(19) United States
(12) Patent Application Publication
(10) Pub. No.: US 2007/0192091 A1
(43) Pub. Date: Aug. 16, 2007

(54) Protection against sound piracy by microphones

(75) Inventor: Angel DeCegama, Westford, MA (US)

Correspondence Address: BORSON LAW GROUP, PC, 1320 WILLOW PASS ROAD, SUITE 490, CONCORD, CA, 94520-5232, US

(73) Assignee: TrueLight Technologies, LLC, Westford, MA (US)

(21) Appl. No.: 11/479,382

(22) Filed: Jun. 30, 2006

Related U.S. Application Data
(60) Provisional application No. 60/696,243, filed on Jul. 1, 2005.

(51) Int. Cl. G10L 21/00

(52) U.S. Cl. 704/225

(57) ABSTRACT

Aspects of this invention include devices and methods for protecting acoustic signals from being pirated by a microphone. Such devices include a signal generator adapted to produce acoustic signals (“aliasing signals”) having frequencies greater than about ½ of the sampling frequency of the microphone Methods for protecting against piracy include providing an acoustical signal within the range of frequencies of normal human hearing to be protected, and a second signal having frequencies above about ½ the sampling frequency of the microphone. Additional aspects include amplifiers for aliasing frequencies and housings for both acoustical signal and aliasing signals.

### CLAIM OF PRIORITY

This application claims priority under 35 U.S.C. Section 119 to U.S. Provisional Patent No. 60/696,243 filed Jul. 1, 2005 titled: “Protection Against Sound Piracy by Camcorders,” Inventor: Angel DeCegama. The above application is herein expressly incorporated fully by reference.

### FIELD OF THE INVENTION

This invention relates to sound recordings and methods for producing sound recordings. In particular, this invention relates to methods of protecting sound recordings from piracy by recording devices, including microphones or camcorders.

### BACKGROUND

One of the major sources of loss of control over sound recordings is the unauthorized re-recording of sound tracks or audio recordings by electronic recording devices. Such unauthorized re-recording is termed “Piracy.” The types of sound recordings subjected to piracy include music records such as CDs, cassette tapes and the like and sound tracks for movies and other audiovisual recordings such as videotapes and DVDs. Businesses that rely upon maintaining control over distribution of such works, whether copyrighted or not, expend large amounts of resources in attempts to prevent piracy.

A common form of piracy of movies and other types of recordings involves the use of microphones or camcorders. Thus, there is a great need in the art for methods to defeat unauthorized copying of recordings by unlicensed individuals.

### SUMMARY

Therefore, in certain aspects of this invention, unauthorized copying can be inhibited by relying upon the general principle that copying of high-fidelity recordings requires a sampling frequency that exceeds the frequencies of the sound recording to be copied. Therefore, in certain embodiments, if the sampling frequency is less than the necessary sampling frequency, a phenomenon termed “aliasing” is produced. Aliasing results in production of signals in the re-recorded version of lower frequencies than were present in the original recording. These lower frequency signals are not part of the original recording, and therefore, are extraneous and may be disturbing to the listener and/or can be used to identify that a recording has been copied. However, these signals are superimposed on the desired content of the copy, and in some embodiments, if the power of the superimposed tones are sufficiently high, they can actually drown out the actual sound of the original recording.

To protect sound recordings using this principle, an additional, high frequency signal can be added to the sound track, either during its production, later if desired or if it is played simultaneously with the playback of the original sound recording. In certain embodiments, the frequencies are sufficiently high so as to be inaudible to the human ear. As such, they do not distract the listener. However, if an unauthorized recording device has a sampling frequency below a threshold for aliasing to occur, the lower frequency signal is produced in the copied version of the sound recording appearing as noise, thereby decreasing or destroying its value as a pirated work.

### BRIEF DESCRIPTION OF THE FIGURES

This invention is described with reference to specific embodiments thereof. Further understanding can be appreciated with reference to the Figures, in which:

FIG. 1 depicts operation of one embodiment of this invention.

### DETAILED DESCRIPTION

The Nyquist Theorem in signal processing states that, in order to be able to recreate exactly a continuous signal from a set of its samples, the sampling frequency, ƒs, must be at least twice the maximum frequency, ƒmax, present in the signal. Thus, ƒs≧2 ƒmax.

If the sampling frequency ƒs is less than 2 ƒmax, the phenomenon of aliasing occurs that results, when trying to reproduce the original signal from its samples, in lower frequency components present in the recording that were not present in the original signal.

In the case of sound, for applications involving human beings, whose hearing range is from about a few Hz to about 20 kHz, frequencies above, for example, 22 kHz cannot be heard. However, in an exemplary case, a tone (e.g., sine wave) of 30 kHz is superimposed on the sound recording while it is being played out, thus producing a combined sound signal having both the original sound signal from the recording and the 30 kHz added signal. In a situation in which a microphone samples the analog sound signal at a frequency of 48 kHz, then the maximum frequency component of the captured sound signal that can be reproduced exactly when played back is 24 kHz according to Nyquist's Theorem even though humans can't hear it. However, the superimposed 30 kHz signal would require a sampling rate of 60 kHz for its exact reproduction, but because it is under-sampled at 48 kHz, aliasing occurs. The aliasing gives rise to a spurious tone of 48 kHz−30 kHz=18 kHz, that is well within the hearing range of most humans. Such a tone is heard as continuous noise that can ruin the sound or musical recording. It can be appreciated that this principle can be applied using a variety of different frequencies. In some embodiments, multiple added signals having different frequencies can be used. For example, if in the example described above, if a second tone having a frequency of 25 kHz is also added, it will produce an aliasing tone of 50 kHz−48 kHz or 2000 Hz, which is well within the range of most humans. It can be appreciated that using multiple added signals can produce a plurality of aliasing tones.

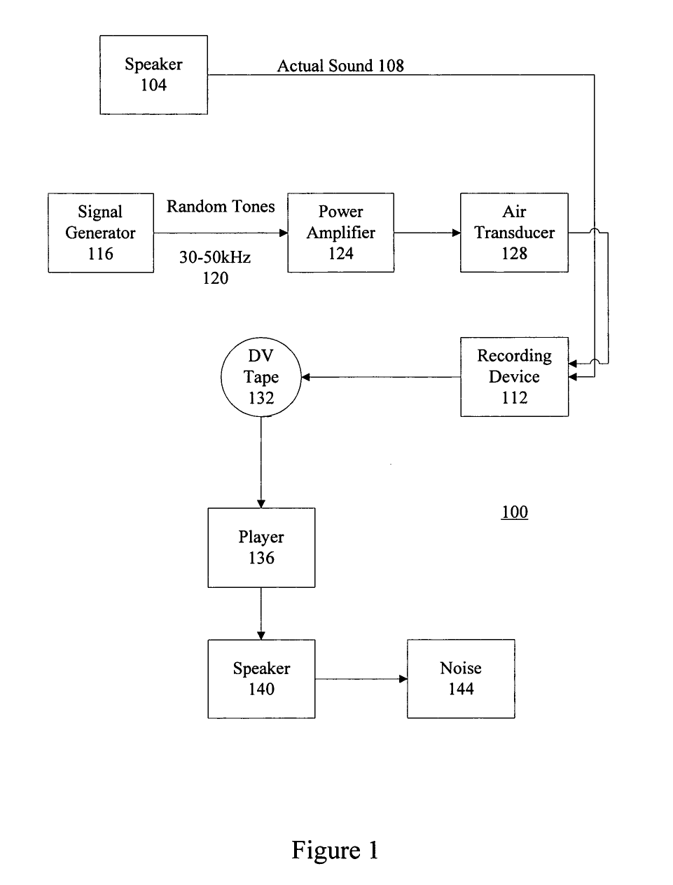

If the power of the superimposed tone is comparable to that of the desired actual sound, the latter can be totally drowned out. This is the basis for the technique of sound protection against piracy as exemplified in Example 1 and as depicted in FIG. 1.

In Example 1 below, there are two independent sources of sound. A first is the sound of the played work, and a second is a source of added tones. When both sources are in operation, a combined sound signal is produced in the air of, for example, a movie theater. In other embodiments, the added tones can be recorded along with the original signal, and when played back, the random tones, when recorded, produce aliasing and a spurious tone, which appears as noise in the pirated recording.

In other embodiments, the random tones are not sine waves. Rather, they can have other waveforms that produce signals of frequency sufficiently high so as to produce aliasing. For example, square waves contain high frequency components, which can be used to produce aliasing. In fact, square waves can be added to an, audio track with a frequency that is in the sub-auditory range of less than about 20 Hz. Even if produced at such low frequencies, the high frequency components of the square wave will produce the desired aliasing. Likewise, triangular waves can be used with similar results as square waves. In other embodiments, high frequency square waves can be used to produce a collection of high-frequency signals. A first set comprises the primary frequency of the generator, for example, 40 kHz. Next, as is known from Fourier or Wavelet transforms, a square or triangular wave of 40 kHz also has higher frequency components. A true square wave, or other wave having a “corner,” in fact, has components of arbitrarily high frequency.

Air transducer arrays can be used to produce signals in the ambient air. Transducer arrays may comprise conventional speakers, but also can comprise devices that have more rigid structures, such as metal plates, vanes and the like. Air transducer arrays and methods for their use are known in the art and need not be described in detail herein.

Protection Against Camcorder Piracy

Embodiments of this invention can also include protections against video signal piracy. Examples of such video protections can be found in U.S. patent application Ser. No. 10/374,824, filed Feb. 25, 2003, and PCT International Application No: PCT/US03/05951, published as WO 03/073625 on Sep. 4, 2003. The above applications are herein expressly incorporated fully by reference.

Even if a pirate figures out the random or added tones and aliasing, it may be very difficult or impossible to circumvent the protections afforded by this invention. A pirate may try to filter out the aliasing sounds using additional circuitry in the recording device. However, this will also eliminate the corresponding frequencies of the actual sound. Moreover, the signal generator can be programmed to produce high frequencies in a random or pseudorandom fashion, aliasing sounds can be produced that cover the entire range of human hearing. In such cases, filtering out aliasing sounds will also filter out the desired signal.

An alternative could be to redesign camcorders or other audio recorders to increase sampling frequencies so that aliasing does not occur. However, with the use of even higher frequencies produced by a signal generator, aliasing will occur, because there is a practical upper limit to the sampling frequency of any sound recording device.

To overcome such attempts to design around the anti-piracy aspects of this invention, one can use of square waves, triangular waves or other waveforms with sharp “corners” because there is no inherent upper limit to the frequencies that can be present in a square wave or other wave having a “corner.” In some embodiments, a square wave may have blunted corners, thereby providing an upper limit to frequencies. In some of these embodiments, the amount of blunting can be randomly varied to provide a randomly variable high frequency limit. These can provide an alternative to changing a primary frequency of a signal. In still other embodiments, square waves can be superimposed on other high-frequency signals (e.g., sine waves) to produce combinations of high frequency signals.

In other aspects, a signal generator, a power amplifier and air transducers can be housed inside speaker boxes, or alternatively, they can be housed separately.

Protection of Music Content From Piracy

In other aspects, this invention includes applications for protection of music from piracy. Currently, much music is being stored to compact disks (CDs) and sold to consumers, who then play the music on CD players.

In certain embodiments involving digitized music, music files can contain the original music that has been digitized (i.e., “sampled”) with samples modified by the addition or subtraction of ultrasonic, high-frequency (HF) tone samples. A superimposed HF signal is already sub-sampled because the sampling rate of the original sound is used. This can result in aliasing and noise generation within the range of human hearing as described above when the files are played.

In other embodiments, music files are downloaded from web sites directly to customers over a network (such as the Internet). Downloaded music can then be played on, for example, an iPod™ or MP3 player. In other aspects of this invention, a music player can be modified to include a simple and inexpensive chip to implement the logic of music content protection. In some embodiments, the chip in the player can eliminate, by subtraction in real time, the superimposed HF samples, leaving the original samples intact, which are then played to reproduce the original music.

One can appreciate that without such modification players can not reproduce the original music from a music file modified as described above.

In certain embodiments, downloading a music file can be encrypted with an encrypter key computed from both the serial number of the purchased file and the ID number of the music player. In these embodiments, the protection chip can decrypt the music file and subtract the added HF samples in real time, and thereby permit the music file to be played without producing aliasing and noise.

One can also produce a limited number of players that can play a given file identified by its serial number. If desired, such players can be registered at the web site for a given music file number.

When protected as described above, unauthorized use can be defeated by incorporating, into a music player, a speaker that can produce a tone outside the range of human hearing (e.g., 24 kHz or higher). When recorded with a conventional microphone, such recordings will be subject to aliasing and production of noise.

In implementing music content protections as described, a content publisher may require manufacturers of players to make one or more of the above-described modifications to decrease the ability of unauthorized users to download and play pirated music.

### EXAMPLE

The following Example is intended to illustrate embodiments of this invention and is not intended to limit the scope of the invention. Other embodiments can be produced based upon the disclosures and teachings of these descriptions, and all such embodiments are considered to be part of this invention.

### Example 1

### Protection Against Movie Theater Piracy

FIG. 1 depicts one embodiment 100 of this invention, including speaker 104, which produces actual sound 108, which is carried through the ambient air of a movie theater. Signal generator 116 produces a sound signal of random tones 120 of about 30 kHz to about 50 kHz. The power of the output produced by signal generator 116 is boosted by power amplifier 124 and air transducer array 128 produces an inaudible, ultrasonic signal, which is also transmitted through the ambient air of the theater to produce a combined sound. Recording device 112 as depicted has a sampling rate of less than 100 kHz.

Recording device 112 captures the combined sound transmitted through the air. Actual sound 108 is recorded without aliasing because the highest frequency in actual sound 108 is less than ½ the sampling rate of recording device 112. However, tones 120 are only captured partially by recording device 112. Because the capture rate of recording device 112 is less than twice the highest frequency in the combined sound, aliasing occurs and a spurious tone is produced. The combined captured signals are relayed to a DV tape 132, then to player 136 and finally to speaker 140, where the spurious tone is played back and is interpreted as noise 144.

The descriptions and examples herein are intended only to illustrate aspects of this invention, and are not intended to limit the scope of the invention. Other aspects and features of the invention can be readily appreciated and produced by those of ordinary skill in the art, and all such embodiments are considered to be part of this invention. All reverences cited herein are fully incorporated by reference.

I claim:

1. A method for protecting against microphone audio piracy, comprising:
(a) providing a first audio signal to be protected, having a range of audio frequencies within the range of human hearing;
(b) providing a second acoustical signal having a second frequency above the range of human hearing, wherein the frequency above the range of human hearing is greater than about ½ of the sampling rate of said microphone.

2. The method of claim 1, wherein said range of frequencies in step (a) has:
a lower limit of: about 20 Hz; and
an upper limit of about 20 kHz.

3. The method of claim 1, wherein the second frequency is above about 20 kHz.

4. The method of claim 1, wherein said steps (a) and (b), when captured by said microphone, produce an aliasing signal.

5. The method of claim 1, wherein in step (b) said second frequency is randomly varied.

6. The method of claim 1, wherein said second frequency has a sinusoidal wave form.

7. The method of claim 1, wherein said second frequency has a waveform having a sharp corner.

8. The method of claim 7, wherein said waveform is a square wave.

9. A device for protecting against microphone audio piracy, comprising:
a signal generator adapted to produce a signal having a frequency above the range of human hearing;
an air transducer; and
a speaker for producing an audio signal to be protected.

10. The device of claim 9, wherein said device and said speaker are within a housing.

11. The device of claim 8, wherein said signal generator is adapted to produce a signal greater than about 20 kHz.

12. The device of claim 8, wherein said signal generator is adapted to produce a randomly varying frequency.

13. The device of claim 8, wherein said signal generator is adapted to produce a wave form having a corner.

14. The device of claim 13, wherein said waveform is a square wave.

15. A method for protecting against music piracy, comprising:
(a) providing a music file containing a signal having a frequency above that of the range of human hearing; and
(b) providing a music player having a filter to remove from said file, said signal having a frequency above that of the range of human hearing.

16. The method of claim 15, wherein said signal has a frequency above about 20 kHz.

17. A music player for playing an audio file containing a signal having a frequency above the range of human hearing, comprising:
a music player; and
a processor having a program that subtracts from said audio file, said signal that has a frequency above the range of human hearing.

18. A system for transmission of audio files across a network, comprising:
a device for producing a digitized file containing an audio signal;
a digitized file containing a sample of digitized audio signal;
a sample containing a frequency above the range of human hearing;
a communication device to transmit said digitized file to a user; and
a player to play back said file, said player having a filter to remove from said file, said sample containing said frequency above the range of human hearing.

19. The system of claim 18, wherein said device for producing a digitized file includes an encrypter said file and said player includes a decrypter said file.
